(19) United States
(12) Patent Application Publication
(10) Pub. No.: US 2004/0198342 A1
(43) Pub. Date: Oct. 7, 2004

(54) Transferring a connection to a local device so that a service feature is available

(75) Inventors: Dirk Blickberndt, Grevenbroich (DE); Stephan Schaade, Buchloe (DE); Klaus Wille, Munich (DE)

Correspondence Address: T LESTER WALLACE, 6601 KOLL CENTER PARKWAY, SUITE 245, PLEASANTON, CA, 94566, US

(73) Assignee: Siemens Aktiengesellschaft

(21) Appl. No.: 10/227,978

(22) Filed: Aug. 26, 2002

(30) Foreign Application Priority Data
Mar. 19, 2002 (DE) 10212137.0

(51) Int. Cl. H04Q 7/00

(52) U.S. Cl. 455/426.1; 455/41.1

(57) ABSTRACT

A system allows a user who uses a portable communications device (for example, a cell phone or PDA) to answer telephone calls to use service features (for example, call forwarding) that are available on a communications system (for example, a corporate communications system), even though the portable device is not a part of the communications system. A transceiver in the telephone establishes a wireless link with a transceiver in a local communications device (for example, a workstation) of the communications system. The user then causes a transfer instruction to pass over the wireless link to the local communications device. This instruction causes the communications connection to be transferred to the local communications device such that the local communications device can be used to handle the call. After the transfer, service features available on the communications system are available to service the call.

### CROSS REFERENCE TO RELATED APPLICATION

This application is based on and hereby claims priority to German Application No. 102 12 137.0 filed on Mar. 19, 2002, in Germany, the contents of which are hereby incorporated by reference.

### TECHNICAL FIELD

The present invention relates to a method for transferring a communications connection from a portable device to a local communications device.

### BACKGROUND

A present-day central communications system generally provides a multiplicity of service features at the various local fixed communications devices of the communications system. These service features are regarded by many users as an indispensable component of everyday communications support. Such service features may include, for example, the familiar functions of “query”, “hold”, “forward”, “broker's call”, “conference call”, etc., which are standard components of modern communications systems.

In order to be able to guarantee constant availability, many users also use portable communications devices along with their local fixed communications device. Portable communications devices include, for example, cells phones or mobile communications terminals or mobile computer units. Examples of such portable devices include PDAs (Personal Digital Assistant), notebook computers, etc. Portable devices of this type are carried almost constantly by a growing number of people. These portable devices are mobile and are often personal in nature and therefore are not generally part of the described communications system.

A user may, for example, keep a portable device for private use, but may also use this portable device for business purposes within the company. The user also has a fixed local communications device (for example, a line-connected telephone disposed at the user's workstation or integrated into the user's workstation) that is part of the company's internal communications system. If the user answers a telephone call using the portable device, then the service features that the user would have otherwise had available had the user answered the call using the fixed local communications device are not available for use with the call. The user may, for example, want to “forward” the call to another person in the company, but this is not possible. A solution is desired.

### SUMMARY

A system and method are provided whereby a user who uses a portable device (for example, a cell phone or PDA) to answer telephone calls can use service features (for example, “call forwarding”) available on a communications system (for example, an internal company communications system), even though the portable device is not a part of the communications system. In one embodiment, the portable device is used to set up or otherwise handle a communications connection (for example, a telephone call). The portable device is not part of the communications system, so the service features provided by the communication system are not available for use with the communications connection. Then, according to one embodiment of the invention, the communications connection is transferred to a local fixed communications device (for example, a telephone or workstation or a communications terminal or a data terminal) that is a part of the communications system.

The transfer of the communications connection from the portable device to the local communications device is carried out using a wireless communications link. The wireless link may, for example, be a two-way Bluetooth microwave communication link. A first Bluetooth transceiver unit is embodied in the local fixed communications device. A second Bluetooth transceiver unit is embodied in the portable device. When the two transceivers are within a communication range of each other, the wireless link is automatically established. To cause the communications connection to be transferred, the user presses a button on the portable device, or activates a touch-sensitive area on the portable device, or otherwise activates the portable device with a spoken command. This user action causes a transfer instruction to be sent via the wireless link from the portable device to the local fixed communications device.

The local communications device receives the transfer instruction and causes the communications connection to transfer to the local communications device so that the local communications device can also be used to take part in the communications connection. After the communications connection is transferred to the local communications device, the service features offered by the central communications system is available to the user even though the communications connection was originally set up on the portable device. The user can therefore, for example, use the user's local communications device to initiate a “query” to contact another subscriber within the communications system.

A further advantage in accordance with an embodiment of the invention is that the user, after answering the communications connection (i.e., the telephone call) on the portable device, can transfer the call to a local communications device that is a line-connected device (for example, a line-connected telephone located at the user's work space). The transfer to such a line-connected device is regarded by most users as an advantageous feature for numerous reasons. For example, using a line-connected device to service the communications connection avoids electromagnetic interference with the connection, avoids the user experiencing electromagnetic radiation transmitted by the portable device, avoids the user feeling heat generated by the portable device which is perceived as unpleasant, and so forth.

Other embodiments and advantages are described in the detailed description below. This summary does not purport to define the invention. The invention is defined by the claims.

### BRIEF DESCRIPTION OF THE DRAWINGS

Embodiments of the invention are explained in more detail below with reference to the drawings, in which:

FIG. 1 is a simplified diagram of a system wherein a communications connection is transferred in accordance with an embodiment of the present invention; and

FIG. 2 is a simplified diagram of a system after transfer of a communications connection in accordance with an embodiment of the present invention.

### DETAILED DESCRIPTION

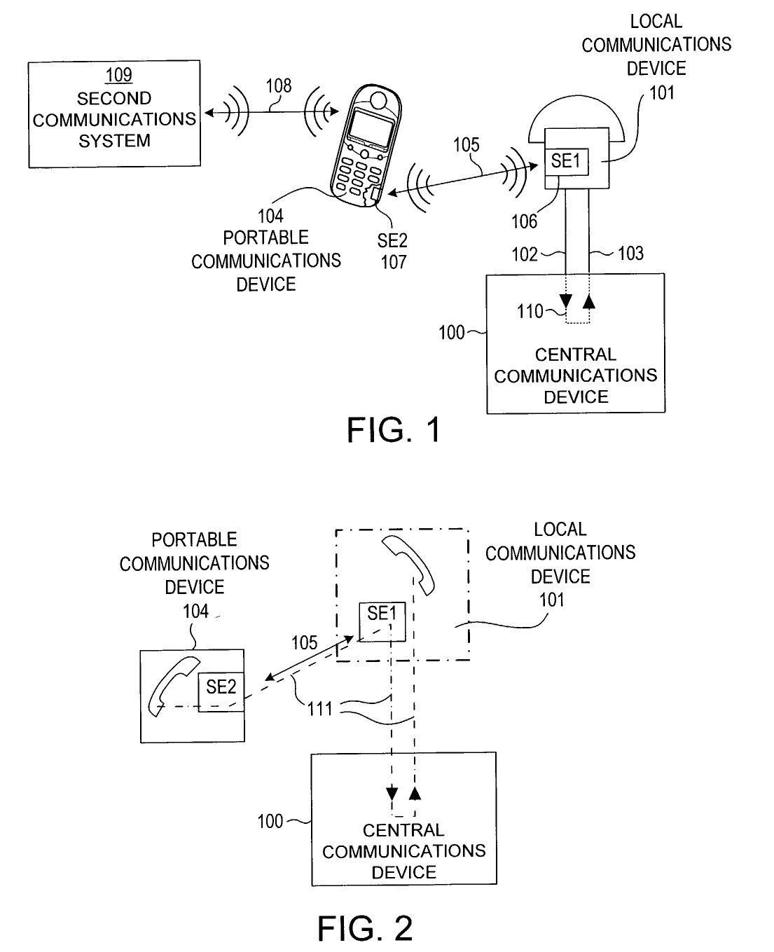

FIG. 1 shows a central communications device 100 coupled to a local communications device 101. User data is communicated between central communications device 100 and local communications device 101 via a first base channel 102 and a second base channel 103. Signaling information is communicated between central communications device 100 and local communications device 101 via a signaling channel (not shown).

In one embodiment, central communications device 100 operates according to a standard known to those of ordinary skill in the art as ISDN (Integrated Services Digital Network) and according to a time-slot-oriented switching principle—often referred to by persons skilled in the art as “Time Division Multiplex”, TDM. Central communications device 100 therefore includes a suitable switching matrix (not shown). Central communications device 100 may, for example, be an ISDN Private Branch exchange (ISDN PBX) device or ISDN switch.

In the case of an ISDN connection, signaling information exchanged via a “D-channel” (not shown) contains data for connection control, signaling, etc. A further component of the information exchanged between central communications device 100 and the local communications device 101 involves user information, which, for example, contains voice and/or video communications data. In an ISDN communications system, this user information is transmitted via one or more base channels B1, B2 (or “B-channels”).

A portable device 104 communicates with local communications device 101 via a low-power and short-range wireless link 105. Two-way data transmission takes place via the wireless link 105 between a first transceiver unit 106 (that is part of or coupled to local communications device 101) and a second transceiver unit 107 (that is part of or coupled to portable device 104). Wireless link 105 may be a radio link such as, for example, a link that satisfies the well-known Bluetooth standard. Alternatively, the wireless link may be an optical interface such as, for example, an IrDA standard link (Infrared Data Association).

Portable device 104 may, for example, be a cell phone, a mobile communications terminal, a Personal Digital Assistant (PDA), or other portable communications device. In FIG. 1, portable device 104 is illustrated as a mobile communications terminal. A user carrying portable device 104 is assumed below to be within wireless communication range of local communications terminal 101.

Initially, the user and portable device 104 is connected via communications connection 108 and a second communications system 109 to a second subscriber (not shown). Communications connection 108 is, in one embodiment, a GSM telephone communication used to establish communication between the user of portable device 104 and the second subscriber.

Next, the user of portable device 104 wishes to “transfer” the communications connection 108 from portable device 104 to local communications device 101. Transfer does not mean that portable device 104 is necessarily disconnected from the communications connection once the “transfer” is made. In this example, transfer means that the local communications device 101 can also be used to take part in the communication connection. Accordingly, the user can, after the transfer, use either portable device 104 or local communications device 104 to take part in communications connection 108.

To initiate activation of the transfer, the user issues a command, for example, by actuating a touch-sensitive area on portable device 104. Alternatively, the user may issue the command by speaking an audible command into a microphone on portable device 104. Alternatively, the user may issue the command to transfer by providing manual or audible inputs to local communications device 101. The user's command causes a transfer instruction to be sent from the portable device 104 to the local communications device 101 via wireless link 105.

Once the user of portable device 104 has initiated activation of the transfer, two-way communication is set up via wireless link 105 whereby transceiver unit 106 acts as a wireless talk-listen combination vis-à-vis transceiver unit 107 in accordance with the Bluetooth standard. This allocation of a “profile” of a respective communications end point on a Bluetooth interface is known to the person skilled in the art from the Bluetooth standard—cf., for example, Bluetooth V1.1 Profile Specifications, Version 1.1 dated 22 Feb. 2001, Part K:6: “Headset Profile”.

Activation of this two-way communication via wireless link 105 may involve second transceiver 107 sending an “identifier” to first transceiver 106. This identifier may, for example, identify the portable device 104 and may be requested by first transceiver 106. This “identifier” mechanism can be used to ensure that only an authorized portable device can initiate transfers of communications connection 108.

From the perspective of central communications device 100, first transceiver unit 106 acts like a telephone of a “virtual subscriber.” This virtual subscriber function of first transceiver unit 106 is largely independent of other functionality of local communications device 101. First transceiver unit 106 therefore provides not only the Bluetooth wireless communication link service, but also a multiplicity of additional services, which are combined into one unit. First transceiver unit 106 may be located outside local communications device 101, or may be an “adapter” that is connected to and plugged into local communications device 101.

Once the two-way wireless communication link 105 is set up, an automatic connection set-up is carried out to establish a connection from first transceiver unit 106 (acting as a virtual subscriber), to central communications device 100, and back to local communications device 101. This connection is indicated in the drawing by a dot-dash line 110 between first base channel 102 and second base channel 103. This automatic connection set-up is set-up using a “hotline to pre-programmed destination” service feature which is a conventional feature of modern communications PBX devices.

The use of two base channels to exchange user data between local communications device 101 and central communications device 100 is advantageous because control of the communications connection is secured by central communications device 100. Second base channel 103 is used to feed the user data back to the local communications device 101 so that the call can be handled on local communications device 101. The user may, for example, switch from using portable device 104 to using a handset (not shown) on local communications device 101 to take part in the call. “De-activation” of the second transceiver unit 107 automatically terminates the connection between first transceiver unit 106 and central communications device 100.

In the event that a call is currently in progress on local communications device 101 (for example, second base channel 103 is currently busy), then the communications connection 108 which is to be transferred can be answered as a second call. Alternatively, the communications connection 108 which is to be transferred can be routed by means of the “call divert on busy” service feature to a different destination within a network of several interconnected communications devices (not shown).

When communications connection 108 is transferred, through-connection of first base channel 102 and second base channel 103 takes place in the switching matrix (now shown) of central communications device 100. This through-connection is shown by the dot-dash line 110. The direction arrows do not indicate the data flow direction of the data exchanged in both directions on the first and second base channels 102, 103, but instead indicate a temporal sequence of the switching processes in central communications device 100.

FIG. 2 is a simplified diagram of portable device 104 and local communications device 101, which are both shown with a handset off-hook, and between which the user data flows. In the example of FIG. 2, the transfer of communications connection 108 has already been carried out. The dot-dash line 111 is a general representation of communications connection 108 after the transfer is complete.

In the embodiments described above, the use of the Bluetooth standard to realize wireless link 105 is advantageous in that it facilitates use of a standardized infrastructure, which is increasingly used in electronic devices with communications interfaces. Furthermore, because the Bluetooth wireless link uses radio signals in the microwave range, the wireless link is not restricted to the portable device 104 having to be in direct line-of-sight contact with local communications device 101.

Although the present invention has been described in connection with certain specific embodiments, the present invention is not limited thereto. Various modifications, adaptations, and combinations of various features of the described embodiments can be practiced without departing from the scope of the invention as set forth in the claims.

What is claimed is:

1. A communications system, comprising:
a local communications device assigned to a central communications device, the local communications device having a first transceiver unit; and
a portable device having a second transceiver unit, the second transceiver unit establishing a wireless link with the first transceiver unit, the wireless link being used to exchange communications information for a transfer of a communications connection from the portable device to the local communications device.

2. The communications system of claim 1, wherein the wireless link conforms to a Bluetooth wireless link standard.

3. A method for transferring a communications connection, the communications connection being between a portable device and an associated communications system, the method comprising:
establishing a wireless link between a first transceiver unit on a local communications device and a second transceiver unit on a portable device; and
transferring the communications connection so that the communications connection extends from the portable device to the local communications device via the wireless link.

4. The method of claim 3, wherein the local communications device is coupled to a central communications device via at least a first base channel and a second base channel, the method further comprising:
using the first and second base channels to communicate user data between the local communications device and the central communication device.

5. The method of claim 4, wherein user data are exchanged between the first transceiver unit and the central communications device via the first base channel, and wherein user data are exchanged between the central communications device and the local communications device via the second base channel.

6. The method of claim 5, further comprising:
using the wireless link to initiate the transfer of the communications connection.

7. The method of claim 6, wherein the transfer is initiated by communicating a defined identifier across the wireless link, the defined identifier identifying one of the first and second transceiver units.

8. The method of claim 7, wherein the transfer is initiated only after a confirmation is input to the portable device.

9. The method of claim 7, wherein the transfer is initiated only after a confirmation is input to the local communications device.

10. The method of claim 4, wherein in order to initiate the transfer, the first transceiver unit transmits an instruction for an automatic connection set-up from the first transceiver unit via the central communications device to the local communications device as a pre-programmed destination to the central communications device.

11. The method of claim 3, wherein the wireless link conforms to a Bluetooth wireless link standard.

12. The method of claim 3, wherein the first transceiver unit identifies itself to the second transceiver unit as a wireless talk-listen combination.

13. The method of claim 3, wherein the portable device has at least some functionalities of a mobile communications terminal.

14. An apparatus, comprising:
a local communications device that is part of a communications system, wherein the local communications device is usable to handle a first telephone call such that a service feature provided by the communications system is usable in handling the first telephone call, the local communications device comprising a first transceiver unit; and
a portable wireless communications device having a second transceiver unit, the second transceiver unit establishing a wireless link with the first transceiver unit, wherein the wireless link is usable to transfer a second telephone call received onto the portable wireless communications device so that after the second telephone call is transferred the local communications device is usable to handle the second telephone call, and wherein after the transfer the service feature is available in handling the second telephone call.

15. The apparatus of claim 14, wherein the service feature is taken from the group consisting of: a “query” service feature, a “hold” service feature, a “forward” service feature, a “broker's call” service feature, and a “conference call” service feature.

16. The apparatus of claim 14, wherein the wireless link is a low power, two-way, microwave communication link.

17. The apparatus of claim 14, wherein the portable wireless communications device is taken from the group consisting of: a cell phone and a Personal Digital Assistant (PDA), wherein the second telephone call is initially set-up as a GSM communication using the portable wireless communications device, wherein the local communications device is a line-connected telephone, and wherein the communications system is a telephone system that comprises a plurality of line-connected telephones.

18. The apparatus of claim 14, wherein after the transfer of the second telephone call either the portable wireless communications device, the local communications device, or both are usable to handle the second telephone call.

19. The apparatus of claim 14, wherein the local communications device comprises a handset, wherein after the transfer the handset is usable to take part in the second telephone call.

20. The appratus of claim 14, wherein the communications system further comprises a central communications device, the local communications device being operatively coupled to the central communications device via a first base channel and a second base channel, and wherein after the transfer the second telephone call extends from the second transceiver unit in the portable wireless communication device via the wireless link to the first transceiver unit in the local communications device, from the first transceiver in the local communications device via the first base channel to the central communications device, through a switch matrix in the central communications device, and then from the central communications device via the second base channel to the local communications device.

21. The apparatus of claim 20, wherein the central communications device is an ISDN PBX switch.

22. The apparatus of claim 14, wherein the transfer is initiated by the portable wireless communication device sending a transfer instruction to the local communications device via the wireless link.

23. The apparatus of claim 14, wherein the transfer instruction is an identifier of the portable wireless communications device.
